(19) United States
(12) Patent Application Publication
(10) Pub. No.: US 2019/0136162 A1
(43) Pub. Date: May 9, 2019

(54) LAUNDRY PRODUCTS

(71) Applicant: Conopco, Inc., d/b/a UNILEVER, Englewood Cliffs, NJ (US)

(72) Inventors: Deborah Jane COOKE, Chester (GB); Katharine Jane SHAW, Bebington, Wirral (GB); David MOORFIELD, Buckley (GB)

(73) Assignee: Conopco, Inc., d/b/a UNILEVER, Englewood Cliffs, NJ (US)

(21) Appl. No.: 16/306,087

(22) PCT Filed: Jun. 1, 2017
(86) PCT No.: PCT/EP2017/063401

§ 371 Date: Nov. 30, 2018

(30) Foreign Application Priority Data
Jun. 9, 2016 (EP) 16173806.7

(51) Int. Cl. C11D 17/04; C11D 3/386; C11D 1/83; D06F 39/02; D06F 33/02

(52) U.S. Cl. CPC C11D 17/041; C11D 3/38645; C11D 3/38636; C11D 3/38627; C11D 1/22; C11D 1/83; D06F 39/022; D06F 33/02; C11D 3/38618

(57) ABSTRACT

A detergent composition is provided in a combination of reservoirs to enable a user to formulate doses of detergent compositions on demand for supplying to a washing machine drum, the combination comprising: a first reservoir containing a stock of a first composition containing a protease component; and a second reservoir containing a stock of a second composition containing at least one selected from a lipase component and/or a cellulase component; and a stock of detergent, which may be in a third reservoir. A system is also provided for a user to formulate bespoke laundry products on demand, the system comprising reservoirs of laundry product components and an apparatus which comprises a dosing unit for supplying a dose of laundry product to a washing machine drum and a device operable to selectively dispense portions of components from the reservoirs as a result of command by the user to provide a dose of laundry product in the dosing unit.

The present invention relates to compositions, systems and methods which provide laundry products tailored to a user's requirement.

In particular, the invention provides compositions, systems and methods which allow a user to customise detergent compositions on demand in order to suit their requirements in their own home.

For many consumers, no single laundry product fulfils all of their needs. As a result, many consumers buy and store more than one laundry product, including biological and non-biological detergent products and those specifically formulated for whites or colours. In addition to storing such laundry products, consumers often store one or more additional stain removal products and/or benefit agents. In total, the combinations can require a significant amount of storage space.

Other consumers may simply use a single laundry product for all loads, regardless of suitability. This can mean that unnecessary components are delivered in the wash (such as enzymes or bleaches) which may have detrimental effects on fabric and/or the environment.

While enzymes are powerful stain removers, for many wash loads some or all enzymes may be omitted. For example, different families of enzymes are effective against different classes of stain, and a large number of laundry loads are not stained at all. Including enzymes in each and every wash may therefore be wasteful.

Furthermore, certain families of enzymes may be incompatible with one another or with other components in a laundry product on prolonged storage. It would be desirable for a user to be able to customise laundry products on demand to combine detergent and appropriate enzyme components prior to wash process, in dependence upon the user's requirements for the proposed wash load.

The present invention seeks to address one or more of the problems identified in the prior art.

### SUMMARY

In a broad aspect the invention provides a multiple dose stock of detergent composition provided in a combination of reservoirs to enable a user to formulate doses of detergent compositions on demand for supplying to a washing machine drum, the combination comprising:

a first reservoir containing a stock of a first composition containing a first enzyme component; and
a second reservoir containing a stock of a second composition containing a second enzyme component; and
a stock of detergent provided in any one of a first or second reservoir or an optional third reservoir.

Preferably the first composition contains a protease component. Also in preferred embodiments the second composition contains at least one selected from a lipase and/or a cellulase component.

A stock of detergent may be provided in a third reservoir. Additionally or alternatively, detergent may be included in a first and/or second reservoir.

Embodiments of the invention thus concern a combination of reservoirs, providing segregated stocks of components for laundry products to enable a user to formulate doses of laundry products on demand for supplying a dose of laundry product to a washing machine drum, the combination comprising
a first reservoir containing a stock of a first enzyme composition which comprises a protease component and
a second reservoir containing a stock of a second enzyme composition which comprises a lipase component and/or a cellulase component, and
a stock of a detergent composition.

Embodiments of the invention provide a combination of independent reservoirs providing components for multiple doses of laundry detergent.

A reservoir may contain a stock of a composition in an amount sufficient for two or more doses, preferably for three or more and more preferably for five or more doses of laundry product. In embodiments of the invention a reservoir contains a stock of a composition in an amount sufficient for at least ten doses, optionally at least fifteen doses, preferably at least twenty doses.

Biological laundry detergent compositions may comprise one or more enzymes. Suitable enzymes include for example, lipases, proteases, amylases, mannanases, cellulases, and pectate lyases.

The inventors have observed that certain enzymes cannot be stored in combination. For example, protease and lipase cannot usually be combined in a single liquid composition because as the protease may digest the lipase on storage. Similarly, protease may digest cellulase on storage in a liquid.

However, protease provides excellent results on treatment of stains derived from grass and blood. Lipase gives excellent benefits on removal of fats, while cellulase gives improved fabric treatment with colour preservation and pill removal and/or background whiteness benefit (depending on the cellulase used). This means that conventional laundry products often contain an enzyme mix.

The present invention permits, through use of more than one laundry enzyme ingredient composition, the assorted benefits of these enzymes to be accessed in a single load. In particular, the invention employs first and second enzyme-containing compositions which are different to one another.

For example, embodiments of the invention comprise a first reservoir containing a first ingredient composition comprising a protease and a second reservoir containing a second ingredient composition comprising a lipase and/or a cellulase. This makes available the combination of protease with a lipase and/or cellulase in a wash process and the stain removal benefits associated with this combination.

The present stock of components is suitable for use with an apparatus for providing laundry product, the apparatus comprising a dosing unit and a dispensing device, wherein the device is operable to dispense portions of components from the stocks so as to provide a dose of laundry product in the dosing unit, ready for a wash process, as a result of input by a user.

A multiple-dose stock of detergent composition according to the invention may also be accommodated in a washing machine which has a dispensing device operable to selectively dispense portions of components from reservoirs as a result of a command by a user to provide a dose of laundry product ready for a wash cycle.

In a second aspect the invention provides a system for a user to formulate bespoke laundry products on demand, the system comprising reservoirs of laundry product components and an apparatus which comprises a dosing unit for supplying a dose of product to a washing machine drum and a device operable to selectively dispense portions of components from the reservoirs as a result of command by the user to provide a dose of laundry product in the dosing unit, wherein the system includes a first reservoir of a composition containing a first enzyme component, a second reservoir of a composition containing a second enzyme component and a reservoir of detergent.

In embodiments of the second aspect, the invention provides a system for a domestic user to formulate bespoke laundry products on demand, the system comprising reservoirs of laundry product components and an apparatus which comprises a dosing unit for supplying a dose of laundry product to a washing machine drum and a device operable to selectively dispense components from the reservoirs as a result of command by the user to provide a dose of laundry product in the dosing unit, wherein the system includes, in a first reservoir, a composition containing a protease component, in a second reservoir, a composition containing a lipase component and/or a cellulase component and, in a third reservoir, a detergent.

The present invention permits the user to combine enzyme components with other laundry detergent ingredients at an appropriate time, ready for a wash process. This can alleviate problems associated with incompatibility between enzyme components in the composition which could occur if the components were stored together for a period of time.

This is especially true of liquid compositions, in which ingredients are more readily able to react on storage. Similarly, especially in the apparatus aspect of the invention, as the product is dosed directly into the dosing unit, it is not necessary that the final composition be substantially homogenous or of a particular viscosity, as is normally the case for commercially supplied laundry liquid products. This permits greater flexibility in the identity of, and relative ratios of, various ingredients.

The present invention also provides additional flexibility for the user as it permits the combination of enzyme components with other laundry product components at various ratios, in accordance with recipes/directions/guidance. This makes available potentially multiple permutations of laundry product compositions from the stock compositions. For example, higher/lower levels of enzyme component may be selected in dependence upon the user's requirements for a particular wash load in terms of the nature and level of soiling, the type of fabric(s) to be washed and the size of the wash load. The present invention thus allows a domestic user to formulate bespoke laundry products in a dosing unit, ready for supply to a washing machine drum.

Embodiments of the present invention may also include directions for combining portions of stock components in order to provide a dose of laundry product.

Methods and devices for combining the contents of the reservoirs are described in more detail below.

The invention also concerns an apparatus for providing laundry product, the apparatus comprising a dosing unit and a dispensing device having reservoirs for containing laundry product components, wherein the device is operable to selectively dispense portions of components from the reservoirs so as to provide a dose of laundry product in the dosing unit as a result of input by a user, wherein the apparatus has a reservoir containing a stock of a composition containing a first enzyme component and a reservoir containing a stock of a composition containing a second enzyme component. Typically the device has a computer programmed to cause the device to selectively dispense components from the reservoirs as a result of input by the user.

Preferably the first enzyme component includes a protease and a second enzyme component includes a lipase and/or a cellulase.

The apparatus may be configured such that the dosing unit and dispensing device are located externally of the washing machine and the dosing unit is adapted to be manually placed in the washing machine, especially in the washing machine drum, or optionally used to supply the dose via a drawer. In other embodiments the apparatus may be associated with the washing machine such that the dispensing device is operable to dispense portions of components into a dosing unit which communicates directly with the washing machine drum. Components may be dispensed directly into the water flow to form a wash liquor or into a chamber or pipe through which water subsequently flows.

Additional reservoirs may be provided containing further laundry product components, in particular active ingredients for laundry detergent. The respective reservoirs are generally separate and segregated from one another. Preferably the apparatus includes at least a third reservoir containing a stock of detergent composition.

Method aspects of the invention concern combining compositions from the reservoirs of the first and second aspects to provide laundry products, and preferably to provide liquid laundry detergent compositions. A preferred method concerns activating an apparatus such as according to the third aspect, to combine portions of stock compositions from the reservoirs so as to provide a dose of a laundry product in a dosing unit, and subsequently supplying the laundry product to the drum of a washing machine.

Embodiments of the invention may also provide a kit for a user to formulate bespoke doses of laundry product, wherein the kit includes a combination of reservoirs providing segregated stocks of laundry product components as described herein, optionally together with directions for combining selected portions of stock components in order to provide various alternative options for a dose of laundry product. A kit may optionally include a dosing unit for accommodating a dose of laundry product to be supplied to a washing machine, suitably by placing a dosing unit in a washing machine drum.

In the various aspects of the invention, the dosing unit may be conventional dosing ball, or may have one or more features designed to complement or otherwise interact with the dosing device.

For the apparatus aspects of the invention, laundry product may be dispensed by a computer module according to input provided before the wash cycle begins Input may be provided in various ways, for example by the user making choices or providing suggestions, or through sensing a tag or label in the article to be laundered such as a QR “quick response code”. Suitably, this input is captured via a user interface on the device. The device may include a graphical user interface (GUI). For example, the GUI may be presented to the user on a digital screen of the user interface. Input from the user may be captured by the user interface of the device via various user interaction mechanisms including: manipulation of buttons, touch screen, voice commands, gestures or other suitable methods. The computer module may communicate with an external user device such as a mobile phone, tablet or laptop to receive user inputs from a user interface on the external device. Using the interface, the user may select a suitable laundry product recipe, or the computer module may select, generate or obtain a recipe based on input from the user (load type, staining, preferences etc). The recipe used to determine the amounts may be obtained from an internal memory within the device, or may be obtained from an external memory accessed, for example, via the internet.

The user interface may include a facility to input data in sets, for example through asking the user to select certain options or alternatives. Accordingly, the device may have or communicate with a user interface via which the user is able to input data using at least two sets of options.

At least one set of options may prompt the user to input stain identity (grass, chocolate, blood etc) and at least one set of options may prompt the user to input fabric colour and/or type. (e.g. cotton, polycotton, polyester).

Based on the data provided for each of these sets, an algorithm may be employed to determine the optimal formulation, balancing the cleaning needs of certain stains against others. The algorithm may be stored and accessed on the computer module of the device, or it may be obtained from an external source such as the internet.

Accordingly, in some cases the computer module is programmed with an algorithm to determine how much product is dosed from each reservoir based on the user input. Thus, in some cases the computer module is programmed to communicate with an external source to access an algorithm and determine how much product is dosed from each reservoir based on the user input.

Each reservoir may be in controllable fluid communication with a dispensing nozzle which dispenses into the dosing unit. The compositions from the various reservoirs may be dispensed directly into the dosing unit (as it is not necessary that the various compositions are mixed before use) or may be dispensed via a pre-mixing chamber, which mixes two or more compositions prior to dispensing.

The reservoirs may be integral to a housing of the device or, more preferably, they may be provided as pre-filled cartridges that cooperate with the housing of the device, such that the composition in the reservoir is in fluid communication with a nozzle for dispensing the composition into the dosing unit or a pre-mixing chamber.

According to preferred embodiments of the invention the reservoirs comprise individual discrete cartridges.

A reservoir cartridge may have stiff walls. In other words, the cartridge may form-retaining so that it can retain its shape regardless of the amount of laundry product in the reservoir. A reservoir cartridge may have flexible walls. It will be appreciated that the cartridge may be configured to suit the overall design and shape of the apparatus. Said reservoir cartridge may be, without limitation, a pouch or stiff plastic container.

Each reservoir cartridge may be fixable to the apparatus such that the contents of the reservoir are sealable by a valve. Suitably, therefore, the cartridge comprises mating means configured to engage with complementary mating means on the apparatus such that, when in place, the reservoir cartridge is held securely and laundry product within the reservoir cartridge is contained or released according to whether the valve of the apparatus is in a closed or open state. In other words, the cartridge may comprise a connecting portion which mates with a complementary connection portion of the apparatus.

Additionally or alternatively, the contents of the reservoir may be supplied by pressure and/or vacuum generated within the device. It will be appreciated that the device may have a pump to move liquids from the reservoirs to the dosing nozzle, optionally via a pre-mixing chamber, to be dispensed.

Accordingly, each reservoir cartridge may be fixable to the device by mating means configured to engage with complementary mating means on the device such that, when in place, the reservoir cartridge is held securely and laundry product within the reservoir cartridge is contained or released according to whether the pump is on or off.

Particularly preferred embodiments of the invention will now be described, by way of example.

### Apparatus

An embodiment of the apparatus aspect of the invention will now be described with reference to the following diagrammatical drawings in which:

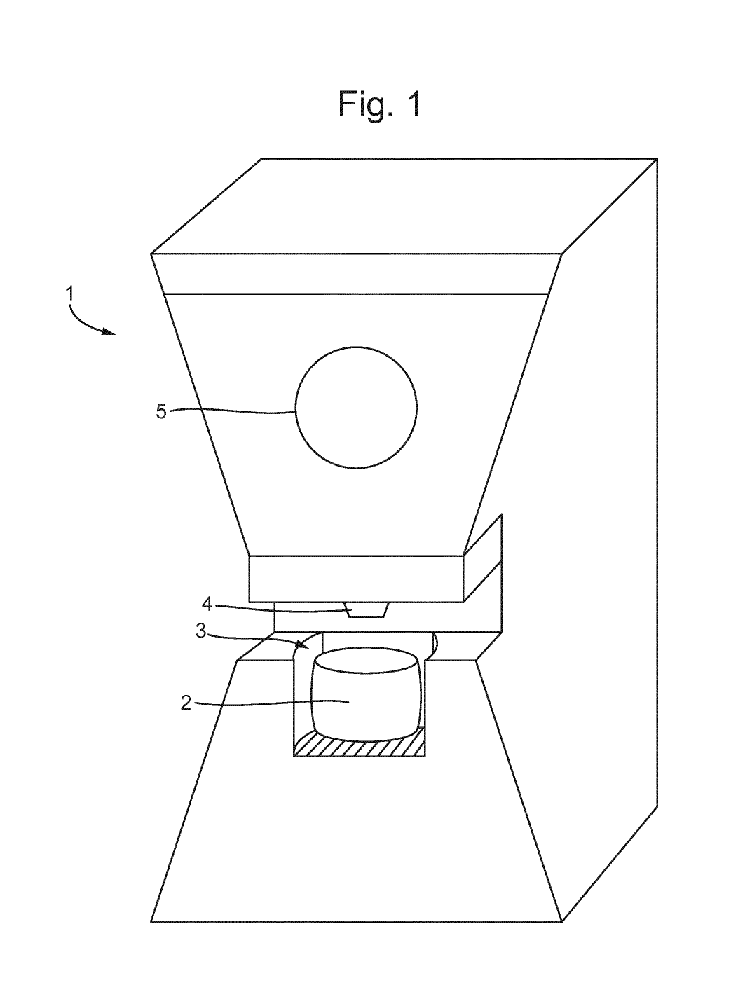

FIG. 1 shows a representative drawing of an apparatus according to an embodiment of the invention.

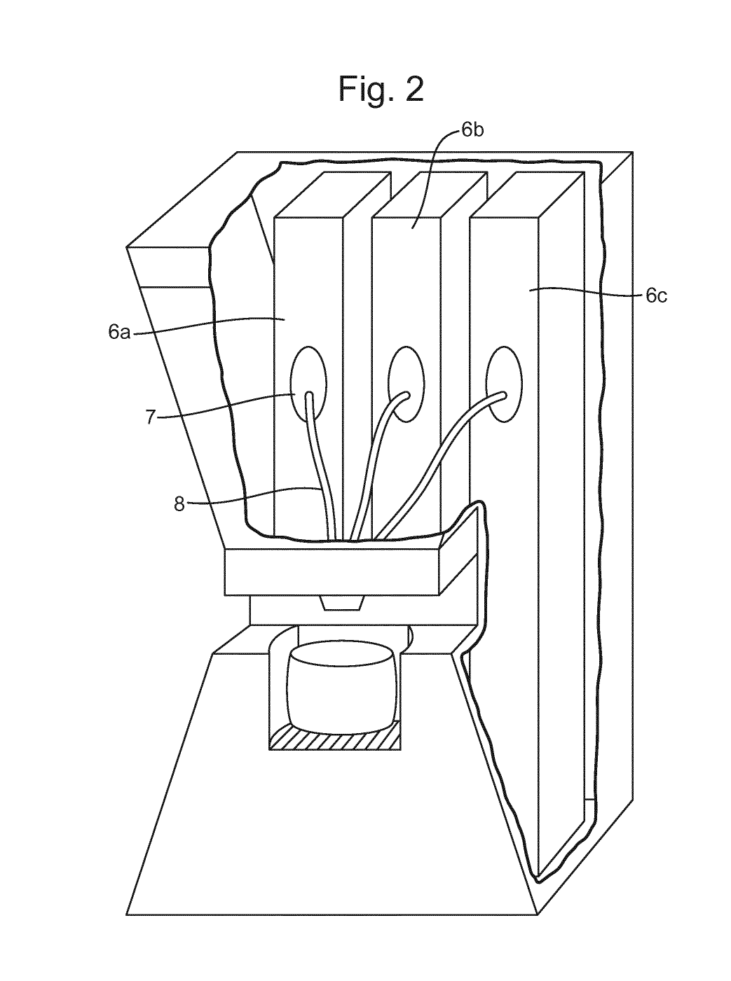

FIG. 2 shows a partially cut away representative drawing of the apparatus showing part of the cartridge arrangement.

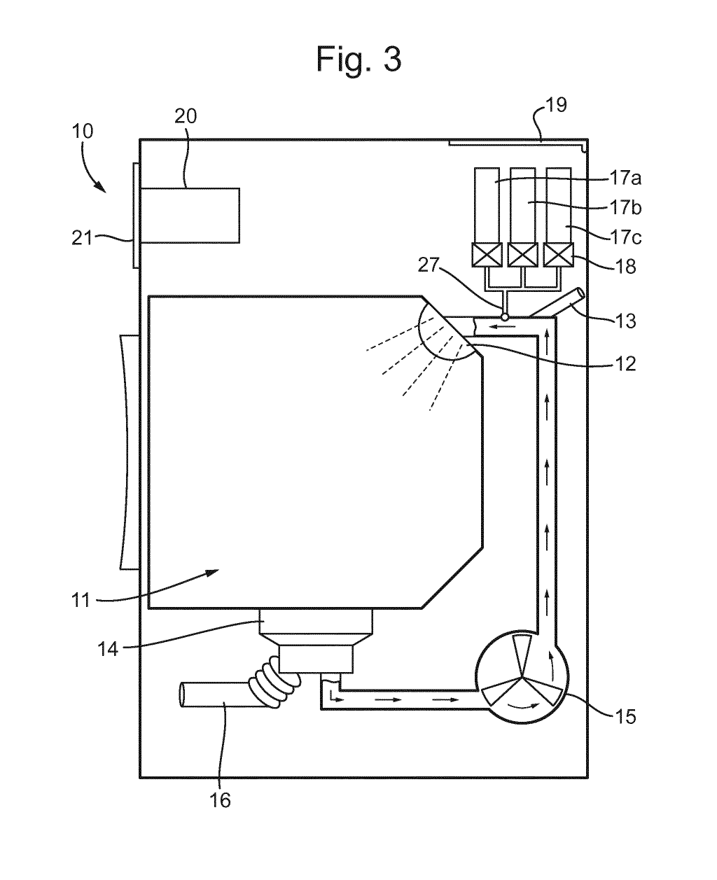

FIG. 3 shows a cross-section drawing of a device for formulating doses of the present compositions wherein the device is integral to a washing machine.

The apparatus as illustrated in FIG. 1 has a dispensing device 1 and a dosing unit 2. The apparatus is a standalone device, designed to be placed on a countertop or similar. For example, it may be placed on a countertop in a kitchen or utility room, or may be placed on top of a washing machine.

As illustrated, the dosing unit 2 is a conventional dosing ball, which is typically made of plastics material. In use, the dosing unit is placed in a dispensing area 3 located underneath a nozzle 4. As illustrated, the dispensing area 3 is a recess provided in the device housing, and the dosing unit 2 is placed on a surface provided in the housing. However, it will be appreciated that the housing may be shaped in different ways such that, for example, the dosing unit is placed directly on the countertop (or other surface on which the device is placed) in use.

Laundry product ingredients are dispensed into the dosing unit 2 via the nozzle 4. As shown, only one nozzle is used. However, it will be appreciated that more than one nozzle may be provided. For example, different reservoirs may be in fluid communication with different nozzles such that a first reservoir is in fluid communication with a first nozzle and a second reservoir is in fluid communication with a second nozzle.

The device has a control/information interface 5. As illustrated, the interface 5 is a touch screen provided in the housing that both displays information and allows selections and information to be inputted to a computer module (not shown).

However, in other embodiments the device may be provided with a panel having buttons, dials or similar for inputting information. In other embodiments, input may be conveyed via command or gesture. It will be appreciated that a display screen in the housing of the device is not essential. The device may be configured for use without a display screen, or an external display screen on for example a phone or tablet may be coupled to the device (for example, via Bluetooth or similar).

FIG. 2 shows a partially cutaway image of the apparatus of FIG. 1. In this embodiment the interior houses three reservoir cartridges 6a, 6b, and 6c. Each cartridge houses a stock of an ingredient composition.

For example, in this non-limiting illustrated embodiment, 6a houses a detergent base composition, 6b houses a composition containing a first enzyme component, and 6c houses a composition containing a second enzyme component. Each cartridge 6a, 6b, 6c has a valve 7 and each cartridge is in fluid communication with a nozzle via a flow path 8. Flow from a cartridge to the nozzle 4 (where it is dispensed) is controlled by the valve. In this embodiment therefore each valve is a metering valve, with the volume metered controlled by the computer module. The valves may be located at any point along the flow path, and other types of valve may be used. Also metering of the ingredient compositions may be achieved in other ways, for example through generation of pressure in the reservoir to force the liquid out.

The diagram shows individual flows running from each reservoir to the nozzle 4. It will be appreciated that flow paths may meet before the nozzle is reached. For example, the device may have a pre-mixing chamber in which different ingredient compositions meet before they are dispensed into the dosing unit.

In use, the dosing unit is located under the nozzle 4 (such that product dispensed through the nozzle enters a chamber of the doing device). The user inputs information about the laundry load to the computer module. Typically, data may be entered in two or more sets, each set requiring certain information from the user. For example, Set I may be used to input the load type: whites or colours. Set II may be used to input the presence or absence of staining and, optionally, the stain type. The user may therefore select whites, grass stains, mud stains. Other data requirements may include the fabric type (cotton/polycotton/polyester) as optimal fabric care benefit agents and amounts may be different in each case; fragrance selection (different members of the household may prefer different fragrances for their clothing, or it may be desirable to fragrance bedding and towels but not clothes); extent of staining (for example, lots of grass stains, only light mud stains; size of load (small loads may require less product).

An optimised wash composition is then determined and the appropriate amount from relevant cartridges dispensed. The computer module (not shown) controls the amount dispensed.

The recipe used to determine the amounts may be obtained from an internal memory within the device, or may be obtained from an external memory accessed, for example, via the internet. Often, particularly where there is more than one stain type, an algorithm may be employed to determine the optimised formulation, balancing the cleaning needs of certain stains against others.

For example, depending on the nature of the stain, it may be appropriate to dispense 6a and one of 6b or 6c to provide the laundry product, or to dispense from all 6a, 6b and 6c. In addition, if enzyme components 6b and 6c are not required the user is able to dispense from 6a alone.

As described herein, the device may be separate to a washing machine, for example on a countertop or built into a kitchen, or may be integral to a washing machine. In other embodiments a dispensing device and/or a dosing unit may be accommodated within a washing machine. The dosing unit may be arranged in fluid communication with the washing machine drum so that the dose of laundry product is supplied without the need for the user to handle it.

FIG. 3 illustrates an embodiment of the invention in which the device is integral to a washing machine 10. The washing machine has a drum area 11 in which articles are laundered. During a wash program, water and wash liquor enter the drum via a sprayer 12. Water enters the machine via inlet 13 (schematically and only partially shown). Water and wash liquor drain from the drum area 11 into a sump 14 and may then recirculate via recirculating pump 15 (arrows indicate direction) to be resprayed into the drum area, or may be drained via waste outlet 16. The illustrated device has three reservoirs 17a, 17b, and 17c. As shown, these are cartridges that engage with dispensing means 18, although it will be appreciated that the reservoirs may be provided simply as containers into which compositions are poured. The cartridges may be loaded and changed through access flap 19.

The device has a computer module 20. As described herein the computer module controls which and optionally how much of each cartridge is dispensed. As shown here, the washing machine has a control panel 21 via which input may be provided to the computer module. As illustrated, the control panel is a touch screen. In the present case, the control panel and computer module are also the used to determine the machine program, although it will be appreciated that they may be separate.

As previously described, in use the user inputs information about the laundry load to the computer module 20. The optimal wash composition is then determined and the appropriate amount from relevant cartridges dispensed by dispensing means 18 and may be combined before entering the water flow of the machine, for example in a single pipe or chamber. This may be termed a pre-mixing area 27. As illustrated, three individual pipes combine to a single pipe, via which the product is dosed. In other words, the ingredient compositions dispensed may be at least partially premixed before being diluted to provide a wash liquor. The computer module controls the amount dispensed.

It will be appreciated that various further reservoir cartridges may be provided, each containing one or more ingredients for a laundry product to enhance versatility of the system. For example, additional reservoir cartridges could be provided for bleach components or any cleaning polymers which are incompatible for storage with an enzyme.

The user may select various options, such as type of stain and type of fabric, and the computer module may then dose appropriate amounts of components from the relevant reservoir cartridge in to the dosing ball ready to be introduced in to the washing machine drum by the user.

Embodiments of components for the laundry product are described below.

### First Composition/Reservoir

The first composition contains a first enzyme component. Typically this composition will contain at least a protease component. Mixtures of proteases may be included.

### Protease

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Example commercially available protease enzymes include Alcalase™, Savinase™, Primase™, Duralase™, Dyrazym™, Esperase™ Everlase™, Polarzyme™, and Kannase™, (Novozymes NS), Maxatase™, Maxacal™ Maxapem™, Properase™, Purafect™, Purafect OxP™, FN2™, and FN3™ (Genencor International Inc.). Alcalase™ and Savinase™ are particularly preferred.

Protease enzymes which exhibit a maximum activity in a range including pH 6 and above, including pH 7 and above, particularly pH 8 and above, especially pH 9 and above, and optionally pH 9.5 and above may be employed. Savinase™ enzyme which has an optimum pH of 10 and Alcalase™ which has an optimum pH in the range of 6.5 to 8.5 are particularly preferred.

### Enzyme Stabilizers/Carriers

The composition will generally contain a carrier liquid to stabilise the protease, and preferably an essentially non-aqueous carrier liquid. Example carrier liquids include polyols, and especially diols and polyols selected from glycerol, sorbitol and monopropylene glycol (MPG) and sugar alcohols and salts thereof.

Glycerol and MPG are particularly preferred.

### Concentration Ranges

The first composition may optionally contain up to 5% aep (active enzyme protein) of the protease component, preferably up to 4% aep, more preferably up to 3% aep, especially up to 2% aep, and optionally up to 1% aep. Generally a composition may contain at least 0.01% aep, preferably at least 0.02% aep, especially at least 0.03% aep and more preferably at least 0.05% aep of protease component. In this regard, 5% aep corresponds to 5 g of active enzyme protein in 100 g of the composition.

In addition to a protease component, a first enzyme composition may optionally contain a pectate lyase enzyme. Mixtures of pectate lyases may be included.

### Pectate Lyase

Pectate lyases are also called polygalacturonate lyases. Examples of pectate lyases include pectate lyases that have been cloned from different bacterial genera for example Erwinia, Pseudomonas, Klebsiella and Xanthomonas, as well as from Bacillus subtilis (Nasser et al. (1993) FEBS Letts. 335:319-326) and Bacillus sp. YA-14 (Kim et al. (1994) Biosci. Biotech. Biochem. 58:947-949). Purification of pectate lyases with maximum activity in the pH range of 8-10 produced by Bacillus pumilus (Dave and Vaughn (1971) J. Bacteriol. 108:166-174), B. polymyxa (Nagel and Vaughn (1961) Arch. Biochem. Biophys. 93:344-352), B. stearothermophilus (Karbassi and Vaughn (1980) Can. J. Microbiol. 26:377-384), Bacillus sp. (Hasegawa and Nagel (1966) J. Food Sci. 31:838-845) and Bacillus sp. RK9 (Kelly and Fogarty (1978) Can. J. Microbiol. 24:1164-1172) have also been described. Any of the above, as well as divalent cation-independent and/or thermostable pectate lyases, may be used in practicing the invention. A pectate lyase may comprise the pectate lyase disclosed in Heffron et al., (1995) Mol. Plant-Microbe Interact. 8: 331-334 and Henrissat et al., (1995) Plant Physiol. 107: 963-976. Further examples of pectate lyases are disclosed in WO 99/27083 and WO 99/27084; pectate lyases (derived from Bacillus licheniformis) are disclosed in U.S. Pat. No. 6,284,524; pectate lyase variants are also disclosed in WO 02/006442.

Examples of commercially available alkaline pectate lyases include BIOPREP™ and SCOURZYME™ L from Novozymes A/S, Denmark.

Preferred pectate lyases have a maximum activity in a range of 8 to 10.

### Concentration Ranges

The composition may optionally contain up to 5% aep (active enzyme protein) of a pectate lyase component, preferably up to 4% aep, more preferably up to 3% aep, especially up to 2% aep, and optionally up to 1% aep. Preferably a composition may contain at least 0.01% aep, preferably at least 0.02% aep, especially at least 0.03% aep and more preferably at least 0.05% aep of pectate lyase component.

### Ratios of Enzymes in First Composition.

If a pectate lyase component is included in the first composition with a protease component, preferably it is present in a ratio in terms of active enzyme protein in a range of 10:90 to 50:50, and preferably 20:80 to 50:50 of pectate lyase:protease.

In terms of the weight of the two components, preferably the pectate lyase, if present, is included in a ratio in a range of 5:95 to 35:65 of pectate lyase:protease.

### Additional Components

Other enzyme components may optionally be included in the first composition in addition to protease and pectate lyase. Generally lipase is not included in the first composition. Generally cellulase is not included in the first composition.

The first composition may optionally contain additives to stabilise the enzyme component and to adjust pH.

The first composition may optionally contain surfactant components. The first composition may also contain cleaning polymers or benefit agents which are compatible with the enzyme component.

### Second Composition/Reservoir

The second composition contains one or more enzyme components which are incompatible with an enzyme component in the first composition. In the case where the first composition contains a protease, any lipase and/or cellulase are included in the second composition.

The second composition preferably contains a lipase component. Mixtures of lipases may be included.

### Lipase

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422). Examples include those having a high degree of homology with the wild-type lipase derived from Humicola lanuginose, more preferably ones which comprise a polypeptide having an amino acid sequence which has at least 90% sequence identity with the wild-type lipase derived from Humicola lanuginose, most preferably strain DSM 4109.

Other examples are lipase variants for example those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Preferred commercially available lipase enzymes include Lipolase™ and Lipolase Ultra™, Lipex™ and Lipoclean™ (Novozymes NS).

Lipase enzymes which exhibit a maximum activity in a range including pH 8, particularly pH 8 and above, especially pH 9 and above, and optionally pH 9 to 10 are also preferred.

### Enzyme Stabilizers/Carriers

The second composition will typically contain a carrier liquid to stabilise the enzyme component. Example carrier liquids include water, polyols, and especially diols and polyols selected from glycerol, sorbitol and monopropylene glycol (MPG) and sugar alcohols and salts thereof.

Glycerol and MPG are particularly preferred.

### Concentrations

The composition may optionally contain up to 5% aep (active enzyme protein) of a lipase component, preferably up to 4% aep, more preferably up to 3% aep, especially up to 2% aep, and optionally up to 1% aep. Preferably a composition may contain at least 0.01% aep, preferably at least 0.02% aep, especially at least 0.03% aep and more preferably at least 0.05% aep of lipase component.

Preferably at least 20% of the enzyme components in the second composition comprise lipase, more preferably at least 30%, based on the total aep of the composition.

As an alternative to, or in addition to a lipase component, a second composition may contain one or more further enzyme components (other than a protease enzyme).

Preferred additional enzyme components include one or more of cellulase, alpha amylase and mannanase. Mixtures of cellulases, alpha amylases and mannases may be included.

### Cellulase

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™, Endolase™, Renozyme™ (Novozymes NS), Clazinase™ and Puradax HA™ (Genencor International Inc.), and KAC-500(B)™ (Kao Corporation).

Cellulase enzymes which exhibit a maximum activity in a range including pH 8, particularly pH 8 to 10, especially pH 9 and above are also preferred.

The composition may optionally contain up to 5% aep (active enzyme protein) of an alpha cellulase component, preferably up to 4% aep, more preferably up to 3% aep, especially up to 2% aep, and optionally up to 1% aep. Preferably a composition may contain at least 0.01% aep, preferably at least 0.02% aep, especially at least 0.03% aep and more preferably at least 0.05% aep of cellulase component.

Preferably at least 20% of the enzyme components in the second composition comprise cellulase, more preferably at least 30%, based on the total aep of the composition.

### Amylase—Alpha

Suitable amylases include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Fungamyl™ and BAN™ (Novozymes NS), Rapidase™ and Purastar™ (from Genencor International Inc.).

Alpha amylase enzymes which exhibit a maximum activity in a range including pH 8 to 10, especially pH 9 and above are also preferred.

The composition may optionally contain up to 5% aep (active enzyme protein) of an alpha amylase component, preferably up to 4% aep, more preferably up to 3% aep, especially up to 2% aep, and optionally up to 1% aep. Preferably a composition may contain at least 0.01% aep, preferably at least 0.02% aep, especially at least 0.03% aep and most preferably at least 0.05% aep of alpha amylase component.

Preferably at least 10% of the enzyme components in the second composition comprise alpha amylase, more preferably at least 20%, especially at least 30% based on the total aep of the composition.

### Mannanase

Suitable examples of mannanases (EC 3.2.1.78) include mannanases of bacterial and fungal origin. In a specific embodiment the mannanase is derived from a strain of the filamentous fungus genus Aspergillus, preferably Aspergillus niger or Aspergillus aculeatus (WO 94/25576). WO 93/24622 discloses a mannanase isolated from Trichoderma reseei. Mannanases have also been isolated from several bacteria, including Bacillus organisms. For example, Talbot et al., Appl. Environ. Microbiol., Vol. 56, No. 11, pp. 3505-3510 (1990) describes a beta-mannanase derived from Bacillus stearothermophilus. Mendoza et al., World J. Microbiol. Biotech., Vol. 10, No. 5, pp. 551-555 (1994) describes a beta-mannanase derived from Bacillus subtilis. JP-A-03047076 discloses a beta-mannanase derived from Bacillus sp. JP-A-63056289 describes the production of an alkaline, thermostable beta-mannanase. JP-A-63036775 relates to the Bacillus microorganism FERM P-8856 which produces beta-mannanase and beta-mannosidase. JP-A-08051975 discloses alkaline beta-mannanases from alkalophilic Bacillus sp. AM-001. A purified mannanase from Bacillus amyloliquefaciens is disclosed in WO 97/11164. WO 91/18974 describes a hemicellulase for example a glucanase, xylanase or mannanase active. Examples also include the alkaline family 5 and 26 mannanases derived from Bacillus agaradhaerens, Bacillus licheniformis, Bacillus halodurans, Bacillus clausii, Bacillus sp., and Humicola insolens disclosed in WO 99/64619.

Examples of commercially available mannanases include Mannaway™ available from Novozymes NS Denmark.

Mannanase enzymes which exhibit a maximum activity in a range including pH 8 to 10, especially pH 9 and above are also preferred.

The composition may optionally contain up to 5% aep (active enzyme protein) of a mannanase component, preferably up to 4% aep, more preferably up to 3% aep, especially up to 2% aep, and optionally up to 1% aep. Preferably a composition may contain at least 0.01% aep, preferably at least 0.02% aep, especially at least 0.03% aep and most preferably at least 0.05% aep of a mannanase component.

Preferably at least 10% of the enzyme components in the second composition comprise mannanase, more preferably at least 20%, especially at least 30% based on the total aep of the composition.

### Additional Components

The second composition may optionally contain additives to stabilise the enzyme components and to adjust pH. Generally protease is not included in the second composition.

The second composition may optionally contain surfactant components. The second composition may also contain cleaning polymers or benefit agents which are compatible with the enzyme components.

### Third Composition—Concentrated Detergent Base

A third composition containing a concentrated detergent base is preferably used together with the first and second compositions in order to provide a laundry detergent formulation.

Example components for a concentrated detergent base composition include the following:

### Surfactants

A detergent base composition may contain a surfactant system which comprises one or more non-soap surfactant components. Preferred surfactant systems comprise at least anionic or nonionic surfactant. Preferred embodiments contain at least 40 wt %, preferably at least 45 wt % and most preferably at least 50 wt % of a non-soap surfactant system. Suitably the detergent base composition contains up to 80 wt % non-soap surfactant, preferably up to 70 wt %. Soaps may also be included in the compositions, as described later.

Preferably the detergent base composition is substantially free of enzyme components i.e. it is a non-biological detergent.

Anionic Surfactants Preferred anionic surfactants have an anion selected from linear alkyl benzene sulfonate (LAS), primary alkyl sulfate (PAS), alkyl ether sulfate (AES) and mixtures thereof.

Preferred alkyl sulphonates are alkylbenzene sulphonates, particularly linear alkylbenzene sulphonates (LAS) having an alkyl chain length of C₈-C₁₅. The counter ion for anionic surfactants is generally an alkali metal (such sodium) or an ammoniacal counterion (such as MEA, TEA). Suitable anionic surfactant materials are available in the marketplace as the ‘Genapol’™ range from Clariant. Preferred linear alkyl benzene sulphonate surfactants are Detal LAS with an alkyl chain length of from 8 to 15, more preferably 12 to 14. LAS is normally formulated into compositions in acid, i.e., HLAS form and then at least partially neutralized in-situ. Other common anionic surfactants are generally provided in pre-neutralised form.

The compositions may also contain base to provide a counterion for any anionic surfactant, together with performing pH adjustment. Typically a base provides a counterion selected from Na+, K+ and ammoniacal ions. Suitable bases include potassium hydroxide, sodium hydroxide, monoethanolamine, diethanolamine and triethanolammine. Most preferred bases include potassium hydroxide and monoethanolamine. Mixtures of bases may be employed. The composition may optionally contain from 0.1 wt % to 20 wt %, preferably from 0.2 wt % to 15 wt %, more preferably 1 to 10 wt % and of base.

A detergent base composition may optionally include an alkyl polyethoxylate sulphate anionic surfactant of the formula (I):

RO(C₂H₄O)ₓSO₃⁻M⁺ (I)

where R is an alkyl chain having from 10 to 22 carbon atoms, especially 12 to 16 carbon atoms and is saturated or unsaturated, M is a cation which makes the compound water-soluble, especially an alkali metal, ammonium or substituted ammonium cation, and x averages from 1 to 15, especially 1 to 3. An example is the anionic surfactant sodium lauryl ether sulphate (SLES) which is the sodium salt of lauryl ether sulphonic acid in which the predominantly C12 lauryl alkyl group has been ethoxylated with an average of 3 moles of ethylene oxide per mole.

Typically a non-soap surfactant system will contain less than 20 wt % of alkyl polyethoxylate sulfate anionic surfactant.

Some alkyl sulphate surfactant (PAS) may be used, especially the non-ethoxylated C₁₂₋₁₅ primary and secondary alkyl sulphates. An example material, commercially available from Cognis, is Sulphopon 1214G.

When included therein the composition may contain from 0.1 wt % to 50 wt %, preferably 0.2 wt % to 50 wt %, more preferably 1 wt % to 45 wt %, and especially 5 to 40 wt % of a anionic surfactant.

### Nonionic Surfactants

Nonionic surfactants include primary and secondary alcohol ethoxylates, especially C₈-C₂₀ aliphatic alcohol ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamide). Mixtures of nonionic surfactant may be used.

When included therein the composition may contain from 0.1 wt % to 50 wt %, preferably 0.2 wt % to 50 wt %, more preferably 1 wt % to 45 wt %, and especially 5 to 40 wt % of a nonionic surfactant, such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Nonionic surfactants that may preferably be used include the primary and secondary alcohol ethoxylates, especially the C₈-C₂₀ aliphatic alcohols ethoxylated with an average of from 1 to 35 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

Preferred surfactant systems comprise nonionic and anionic surfactant in a ratio in the range of 20:80 to 80:20, preferably in the range of 40:60 to 80:20 and more preferably in a range of 40:60 to 70:30.

A particularly preferred surfactant system is provided by anionic surfactant comprising linear alkyl benzene sulfonate (LAS) and nonionic surfactant comprising C₁₀-C₁₅ alcohol ethoxylate with 2 to 7 EO.

### Amine Oxide Surfactants

The surfactant system of the composition may contain an amine oxide of the formula (2):

R¹N(O)(CH₂R²)₂ (2)

In which R¹ is a long chain moiety and each CH₂R² is a short chain moiety. R² is preferably selected from hydrogen, methyl and —CH₂OH. In general R¹ is a primary or branched hydrocarbyl moiety which can be saturated or unsaturated, preferably, R¹ is a primary alkyl moiety having chain length of from about 8 to about 18 and R² is H. These amine oxides are illustrated by C₁₂₋₁₄alkyldimethyl amine oxide, hexadecyl dimethylamine oxide, octadecylamine oxide.

Example amine oxide materials are Lauryl dimethylamine oxide, also known as dodecyldimethylamine oxide or DDAO, commercially available from Hunstman under the trade name Empigen® OB.

Amine oxides suitable for use herein are also available from Akzo Chemie and Ethyl Corp. See McCutcheon's compilation and Kirk-Othmer review article for alternate amine oxide manufacturers.

Preferably the detergent compositions contain less than 10 wt %, more preferably less than 5 wt % and especially less than 2 wt % amine oxide surfactant.

### Zwitterionic Surfactants

Some zwitterionic surfactant, such as sulphobetaine, may be present. A preferred zwitterionic material is a betaine available from Huntsman under the name Empigen® BB.

Preferably the detergent compositions contain less than 10 wt %, more preferably less than 5 wt % and especially less than 2 wt % zwitterionic surfactant.

A particularly preferred surfactant system is provided by anionic surfactant comprising linear alkyl benzene sulfonate (LAS) and nonionic surfactant comprising C₁₀-C₁₅ alcohol ethoxylate with 2 to 7 EO.

### Cationic Surfactants

Cationic surfactants are preferably substantially absent from the third composition which provides a detergent base composition.

### A Polymer System

A detergent base composition may preferably contain a polymer system which comprises at least one of the following (bi) to (biii):
(bi) one or more particulate soil removal polymer(s) and/or
(bii) one or more anti-redeposition polymer(s) and/or
(biii) one or more soil release polymer(s).

The inclusion of such a polymer system results in enhanced weight efficiency for the compositions. In particular it has been found that such a polymer system contributes to the good dissolution characteristics of the compositions and allows for a reduction in the amount of other non-functional components and solvents required in order to achieve acceptable dissolution.

Example compositions may preferably contain up to 25 wt %, more preferably up to 20 wt % and especially up to 18 wt % of the polymer system. Preferably the compositions contain at least 5 wt %, preferably at least 6 wt % and more preferably at least 7 wt % of the polymer system.

Embodiments may employ an ethoxylated polyethylene imine polymer (EPEI) which may assist with particulate soil removal and/or perform an anti-redeposition function. Preferably the EPEI is nonionic. That means it does not have any quaternary nitrogens, or nitrogen oxides or any ionic species other than possible pH affected protonation of nitrogens.

Polyethylene imines (PEIs, especially modified PEIs) are materials composed of ethylene imine units —CH2CH2NH— and, where branched, the hydrogen on the nitrogen is replaced by another chain of ethylene imine units. These polyethyleneimines can be prepared, for example, by polymerizing ethyleneimine in the presence of a catalyst such as carbon dioxide, sodium bisulphite, sulphuric acid, hydrogen peroxide, hydrochloric acid, acetic acid, and the like. Specific methods for preparing these polyamine backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; U.S. Pat. No. 2,553,696, Wilson, issued May 21, 1951 and WO2006/086492 (BASF).

Preferably, the EPEI comprises a polyethyleneimine backbone wherein the modification of the polyethyleneimine backbone is intended to leave the polymer without quaternisation. Such nonionic EPEI may be represented as PEI(X)YEO where X represents the molecular weight of the unmodified PEI and Y represents the average moles of ethoxylation per nitrogen atom in the polyethyleneimine backbone. The ethoxylation number Y may range from 9 to 40 ethoxy moieties per modification, preferably it is in the range of 16 to 26, most preferably 18 to 22. X is selected to be from about 300 to about 10000 weight average molecular weight and is preferably about 600.

A preferred example EPEI is PEI (600) 20EO.

If present, the polymer (bi) and/or (bii), such as ethoxylated polyethyleneimine polymer (EPEI), may typically be included in the composition at a level of between 0.01 and 20 wt %, and preferably at a level of at least 1 wt % and/or less than 18 wt %, more preferably at a level of from 2 wt % and/or up to 15 wt %. Particularly preferred compositions contain 3 wt % to 10 wt % and especially 5 to 10 wt % or 4 to 10 wt % EPEI. A ratio of non-soap surfactant to EPEI may preferably be from 2:1 to 9:1, preferably from 3:1 to 8:1, or even to 3:1 to 7:1.

In other embodiments a polymer (bi) and/or (bii) may be omitted.

### Soil Release Polymer

A polymer system of the composition preferably comprises at least some soil release polymer for oily soil removal, especially from polyester.

Soil release polymers improve the main wash performance of the compositions when used in the low in wash surfactant process of the present invention.

One preferred class of polymer is the fabric-substantive polymers comprising at least one of (i) saccharide or (ii) dicarboxylic acid and polyol monomer units. Typically these have soil release properties and while they can have a primary detergency effect they generally assist in subsequent cleaning. Preferably these should be present at a level of at least 2% wt preferably at least 3 wt % of the composition.

If present, the soil release polymer(s) (biii) will generally comprise up to 12.0 wt %, of the detergent composition, preferably up to 9 or 10 wt %. Preferably they are used in an amount of at least 1 or perhaps 2 wt %. Most preferably they are used in an amount of 1 to 9 wt %, more preferably 2 wt % to 9 wt %, especially 2 wt % to 8 wt %.

Generally the soil release polymers for polyester will comprise polymers of aromatic dicarboxylic acids and alkylene glycols (including polymers containing polyalkylene glycols).

The polymeric soil release agents useful herein especially include those soil release agents having:

(a) one or more nonionic hydrophilic components consisting essentially of:
(i) polyoxyethylene segments with a degree of polymerization of at least 2, or
(ii) oxypropylene or polyoxypropylene segments with a degree of polymerization of from 2 to 10, wherein said hydrophilic segment does not encompass any oxypropylene unit unless it is bonded to adjacent moieties at each end by ether linkages, or
(iii) a mixture of oxyalkylene units comprising oxyethylene and from 1 to about 30 oxypropylene units wherein said mixture contains a sufficient amount of oxyethylene units such that the hydrophilic component has hydrophilicity great enough to increase the hydrophilicity of conventional polyester synthetic fibre surfaces upon deposit of the soil release agent on such surface, said hydrophilic segments preferably comprising at least about 25% oxyethylene units and more preferably, especially for such components having about 20 to 30 oxypropylene units, at least about 50% oxyethylene units; or
(b) one or more hydrophobic components comprising:
(i) C₃ oxyalkylene terephthalate segments, wherein, if said hydrophobic components also comprise oxyethylene terephthalate, the ratio of oxyethylene terephthalate:C₃ oxyalkylene terephthalate units is about 2:1 or lower,
(ii) C₄-C₆ alkylene or oxy C₄-C₆ alkylene segments, or mixtures therein,
(iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fibre surfaces and retain a sufficient level of hydroxyls, once adhered to such conventional synthetic fibre surface, to increase fibre surface hydrophilicity, or a combination of (a) and (b).

Typically, the polyoxyethylene segments of (a)(i) will have a degree of polymerization of from about 200, although higher levels can be used, preferably from 3 to about 150, more preferably from 6 to about 100. Suitable oxy C₄-C₆ alkylene hydrophobic segments include, but are not limited to, end-caps of polymeric soil release agents such as MO₃S(CH₂)ₙ OCH₂CH₂O—, where M is sodium and n is an integer from 4-6, as disclosed in U.S. Pat. No. 4,721,580, issued Jan. 26, 1988 to Gosselink.

Soil release agents characterized by poly(vinyl ester) hydrophobic segments include graft copolymers of poly(vinyl ester), e.g., C₁-C₆ vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type of material, e.g., SOKALAN HP-22, available from BASF (West Germany).

One type of preferred soil release agent is a copolymer having random blocks of ethylene terephthalate and polyethylene oxide (PEO) terephthalate. The molecular weight of this polymeric soil release agent is in the range of from about 25,000 to about 55,000. See U.S. Pat. No. 3,959,230 to Hays, issued May 25, 1976 and U.S. Pat. No. 3,893,929 to Basadur issued Jul. 8, 1975.

Another preferred polymeric soil release agent is a polyester with repeat units of ethylene terephthalate units contains 10 to 15 wt % of ethylene terephthalate units together with 90 to 80 wt % weight of polyoxyethylene terephthalate units, derived from a polyoxyethylene glycol of average molecular weight 300-5,000. Examples of this polymer include the commercially available material ZELCON 5126 (from DuPont) and MILEASE T (from ICI). See also U.S. Pat. No. 4,702,857, issued Oct. 27, 1987 to Gosselink.

Another preferred polymeric soil release agent is a sulphonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451, issued Nov. 6, 1990 to J. J. Scheibel and E. P. Gosselink. Other suitable polymeric soil release agents include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27, 1987 to Gosselink.

Preferred polymeric soil release agents also include the soil release agents of U.S. Pat. No. 4,877,896, issued Oct. 31, 1989 to Maldonado et al, which discloses anionic, especially sulfoarolyl, end-capped terephthalate esters.

Still another preferred soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulphonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

Suitable soil release polymers are described in WO 2008095626 (Clariant); WO 2006133867 (Clariant); WO 2006133868 (Clariant); WO 2005097959 (Clariant); WO 9858044 (Clariant); WO 2000004120 (Rhodia Chimie); U.S. Pat. No. 6,242,404 (Rhodia Inc); WO 2001023515 (Rhodia Inc); WO 9941346 (Rhodia Chim); WO 9815346 (Rhodia Inc); WO 9741197 (BASF); EP 728795 (BASF); U.S. Pat. No. 5,008,032 (BASF); WO 2002077063 (BASF); EP 483606 (BASF); EP 442101 (BASF); WO 9820092 (Proctor & Gamble); EP 201124 (Proctor & Gamble); EP 199403 (Proctor & Gamble); DE 2527793 (Proctor & Gamble); WO 9919429 (Proctor & Gamble); WO 9859030 (Proctor & Gamble); U.S. Pat. No. 5,834,412 (Proctor & Gamble); WO 9742285 (Proctor & Gamble); WO 9703162 (Proctor & Gamble); WO 9502030 (Proctor & Gamble); WO 9502028 (Proctor & Gamble); EP 357280 (Proctor & Gamble); U.S. Pat. No. 4,116,885 (Proctor & Gamble); WO 9532232 (Henkel); WO 9532232 (Henkel); WO 9616150 (Henkel); WO 9518207 (Henkel); EP 1099748 (Henkel); FR 2619393 (Colgate Palmolive); DE 3411941 (Colgate Palmolive); DE 3410810 (Colgate Palmolive); WO 2002018474 (RWE-DEA MINERALOEL & CHEM AG; SASOL GERMANY GMBH); EP 743358 (Textil Color AG); PL 148326 (Instytut Ciezkiej Syntezy Organicznej “Blachownia”, Pol.); JP 2001181692 (Lion Corp); JP 11193397 A (Lion Corp); RO 114357 (S.C. “Prod Cresus” S.A., Bacau, Rom.); and U.S. Pat. No. 7,119,056 (Sasol).

The most preferred soil release polymers are the water soluble/miscible or dispersible polyesters such as: linear polyesters sold under the Repel-O-Tex brand by Rhodia (Gerol), or the Texcare brand by Clariant, especially Texcare SRN100 and SRN170, and heavily branched polyesters such as those available from Sasol and described in U.S. Pat. No. 7,119,056. The polyesters are preferably nonionic and comprise a mid block of spaced apart terephthalate repeat units and at least one end block based on polyethylene glycol with a lower alkyl or hydrogen termination.

Example soil release polymers may also be of the type E-M-L-E, where the ester midblock M is connected to generally hydrophilic end blocks E, each comprising capped oligomers of polyethylene glycol, the linking moiety L is of the form B—Ar—B, where B is a urethane, amide or ester moiety. Such soil release polymers are described in WO2012/104159.

Particularly preferred polymer systems (bi), (bii) and (biii) are combinations of relatively high levels of EPEI, particularly greater than 2.5 wt % based on the composition, with soil release polymers.

The polymer system (b) may typically be present in an amount such that the ratio of polymer system (b) to surfactant system (a) is in a range of 0.15:1 to 0.4:1, preferably 0.2:1 to 0.4:1 and more preferably 0.2:1 to 0.3:1.

### Water

The detergent base compositions are intended to be highly weight efficient and as such may contain relatively low levels of water, preferably up to 15 wt % added water. Preferred embodiments contain up to 12 wt % and more preferably up to 10 wt % added water. The amount of water will vary in dependence upon the dose volume required.

The compositions may also contain water provided as a component of a raw material. Preferably the total water content of the composition (as provided by the raw materials and as added water) is less than 20 wt %, preferably less than 15 wt % and more preferably less than 12 wt %.

### Fatty Acid/Soap

The detergent base compositions may comprise fatty acid and/or soap, preferably in an amount up to 10 wt %, especially up to 8 wt % and most preferably up to 5 or 6 wt % fatty acid. Typically a composition may contain at least 0.1 wt % fatty acid and preferably at least 1 wt %.

Preferred example fatty acids contain 8 to 24 carbon atoms, preferably in a straight chain configuration, saturated or unsaturated. Particularly preferred fatty acids include those where the weighted average number of carbons in the alkyl/alkenyl chains is from 8 to 24, more preferably 10 to 22, most preferably from 12 to 18. Suitably fatty acids include linear and branched stearic, oleic, lauric, linoleic and tallow acids and mixtures thereof.

Particularly preferred blends of fatty acids that are commercially available include: hydrogenated topped palm kernel fatty acid, and coconut fatty acid saturated fatty acids are preferred. The fatty acid can act as a buffer in addition to preforming a builder and/or as an antifoam. Fatty acids may form part of a buffer system that provides buffering in a pH range of 5 to 9. Preferably the present detergent compositions have a pH in those ranges when measured on dilution of the liquid composition to 1% using demineralised water. The most preferred pH range all vary in dependence upon the polymer system; soil release polymers in particular can have reduced stability under certain conditions of pH.

### Base

As described above in relation to the anionic surfactant, a detergent base composition may preferably contain from 1 to 15 wt %, more preferably from 1 to 10 wt % in total of base which may provide a counterion for any anionic surfactant and perform a pH adjustment function. Suitable bases include potassium hydroxide, sodium hydroxide, monoethanolamine, diethanolamine and triethanolammine. A most preferred base is monoethanolamine. Mixtures of bases may be employed.

### Solvent and Hydrotropes

As the present detergent base compositions are intended to be highly weight efficient it is proposed that a base composition contains less than 40 wt %, preferably less than 35 wt %, more preferably less than 30 wt % and especially less than 20 wt % of any solvents and hydrotropes. Generally the solvents are “non-amino functional”.

In this context, “non-amino functional solvent” refers to any solvent that does not contain amino functional groups. It includes non-surfactant solvents such as C₁-C₅ alcohols (such as ethanol), C₂-C₆ diols (such as monopropylene glycol and dipropylene glycol) and C₃-C₉ triols (such as glycerol). In preferred embodiments the solvents are optionally selected from one or more of glycerol, monopropylene glycol (MPG) and ethanol.

The level of such solvents including non-amino functional solvents will vary in dependence upon the dose volumes required. Amino-functional materials are not included in the category of solvents as they would be classified by the skilled reader as a base.

In the present detergent base compositions the combined total amount of added water and solvents is preferably less than 45 wt % and more preferably less than 40 wt %.

### Additional Ingredients Up to 100%

The detergent base compositions may contain additional ingredients such a fragrance, colorants, pearlisers and/or opacifiers, and dye transfer inhibitors. Typically such additional ingredients will be present in a total amount of less than 10 wt %, more preferably less than 9 wt % and especially less than 8 wt %.

Additionally or alternatively, such additional ingredients may be provided in one or more additional reservoirs.

### pH Adjustment

In some embodiments it may be useful to include components in a third or further reservoir which function to adjust the pH of a wash liquor in order to optimise the activity of one or more enzymes. The pH adjustment could be achieved using the detergent base composition or using a further composition specifically intended for pH adjustment. Example pH adjustment may be effected with alkalinity sources such as: alkanolamines, such as monoethanolamine MEA, diethanolamine, and triethanolamine TEA, and preferably MEA; alkali metal hydroxides, such as NaOH and KOH; alkali metal carbonates and bicarbonates such as sodium carbonate/bicarbonate and alkali metal silicates such as sodium silicate.

### External Structurants

The compositions may have their rheology further modified by use of a material or materials that form a structuring network within the composition. Suitable structurants include hydrogenated castor oil, microfibrous cellulose and natural based structurants for example citrus pulp fibre. Citrus pulp fibre is particularly preferred especially if lipase enzyme is included in the composition. Preferably, if utilised, such external structurants are present in an amount of less than 2 wt %, preferably less than 1 wt %.

### Visual Cues

The compositions may comprise visual cues of solid material that is not dissolved in the composition. Preferred visual cues are lamellar cues formed from polymer film and possibly comprising functional ingredients that may not be as stable if exposed to the alkaline liquid. Enzymes and bleach catalysts are examples of such ingredients. Also perfume, particularly microencapsulated perfume.

### Packages and Dosing

The compositions are preferably in liquid form. Each composition is preferably provided in a reservoir cartridge adapted for use with a dosing device which is operable to selectively dispense portions of a composition from a reservoir into a dosing unit upon command by a user, such as in a manner as described herein. A reservoir cartridge may contain a stock of a composition in an amount sufficient for two or more doses, preferably for three or more and more preferably for five or more doses of laundry product. A cartridge may be disposable or be designed to be refillable.

A combination of cartridges can provide segregated stocks of components in amounts sufficient to provide multiple doses of laundry products. Directions may be provided to guide the user to make certain selections in dependence upon factors such as fabric type and nature of staining. A dosing unit (such as a ball) may also be provided as part of a kit for formulating multiple doses of laundry products.

### EXAMPLES

The following concentrated liquid stock compositions were prepared:

### First Enzyme Composition (for Reservoir 6b)

The following first liquid stock compositions (1.1) to (1.8) were prepared:

### 1.1 Protease Component

Savinase™ ex Novozymes (optimum at pH 10) in a glycerol carrier liquid in an amount of <0.475% aep, with benzisothiazoline-3-one biocide ex Proxel (up to 1% of the composition).

### 1.2 Protease Component

Relase Evity™ 16 L ex Novozymes (<20% on a dry matter basis, <5% aep) in an amount of 9.5% in a glycerol carrier liquid, corresponding to <0.475% aep, with 1% biocide.

### 1.3 Protease Component

Alcalase™ (optimum at pH 6.5 to 8.5) in a glycerol carrier liquid in an amount corresponding to <0.475% aep with 1% biocide.

### 1.4 Protease Component

Carnival Evity™ 16 L ex Novozymes (<10% on a dry matter basis, <10% aep) in an amount of 4.75% in a glycerol carrier liquid, corresponding to <0.475% aep, with 1% biocide.

1.5 to 1.8 Protease Component with Pectate Lyase

Corresponding formulations were prepared with the addition of Expect™ 1000 L ex Novozymes (<5% on a dry matter basis, <2.5% aep) in an amount of 2.8% in a glycerol carrier liquid, providing <0.07% aep pectate lyase in the stock composition.

The volume of each stock solution was 125 ml. The volume designated for a single wash was 5 ml.

### Second Enzyme Composition (for Reservoir 6c)

The following second liquid stock compositions (2.1 to 2.12) were prepared:

### 2.1 Lipase Component

Lipex™ L ex Novozymes in an amount corresponding to <0.125% aep in a glycerol carrier liquid with 1% biocide.

### 2.2 Cellulase Component

Celluclean™ 5000 L ex Novozymes (<10% on a dry matter basis, <5% aep) in an amount corresponding to <0.125% aep in a glycerol carrier liquid with 1% biocide.

### 2.3 Lipase and Cellulase Component

A combination of 2.1 and 2.2 with <0.125% aep Lipex™ and 0.125% aep Celluclean™ 5000 L.

Additional stock solutions were prepared by combining each of 2.1 to 2.3 with (i) an amylase component (2.4 to 2.6), (ii) a mannase component (2.7 to 2.9) and (iii) both amylase and mannase (2.10 to 2.12). In these second stock compositions the amylase was present in an amount of <0.115% aep and the mannase was present in an amount of <0.046% aep.

### Amylase Component

Stainzyme™ (optimum at pH 9) in an amount corresponding to <0.115% aep in glycerol carrier liquid with 1% biocide.

### Amylase Component

Resilience™ 200 L ex Novozymes, (<2.5% on a dry matter basis, <2.5% aep) in an amount of 4.6% in glycerol carrier liquid, corresponding to <0.115% aep with 1% biocide.

### Mannase Component

Mannaway™ 4.0 L ex Novozymes (<2.5% on a dry matter basis, <1% aep) in an amount of 4.6% in glycerol carrier liquid corresponding to <0.046% aep with 1% biocide.

The volume of the stock solution was 125 ml. The volume designated for a single wash was 5 ml.

### Third Composition (for Reservoir 6a)

### Concentrated Non-Biological Detergent Base Compositions

The following liquid stock compositions (3.1) and (3.2) were prepared:

3.1 3.3 wt % water
6.8 wt % MEA
32.6 wt % Nonionic surfactant (C12-C15 alcohol ethoxylate 7EO)
32.6 wt % LAS acid (C12-C14 alkylbenzene sulphonic acid)
5.9 wt % Fatty acid (saturated lauric fatty acid)
9.4 wt % EPEI (ethoxylated polyethylene imine polymer PEI (600) 20EO)
6 wt % Soil release polymer (Texcare SRN100)
0.035 wt % Fluorescent agent (Tinopal CBS-CL)
3.4 wt % fragrance
   3.2 1.3 wt % water
2.0 wt % MPG
6.8 wt % MEA
32.6 wt % Nonionic surfactant (C12-C15 alcohol ethoxylate 7EO)
32.6 wt % LAS acid (C12-C14 alkylbenzene sulphonic acid)
5.9 wt % Fatty acid (saturated lauric fatty acid)
9.4 wt % EPEI (ethoxylated polyethylene imine polymer PEI (600) 20EO)
6 wt % Soil release polymer (Texcare SRN100)
0.035 wt % Fluorescent agent (Tinopal CBS-CL)
3.4 wt % fragrance

The volume of each stock solution was 300 ml. The volume designated for a single wash was 12-20 ml.

The stock compositions were loaded in an apparatus as illustrated in the accompanying drawings. Portions of the stock compositions were combined in a variety of ways so as to provide a range of laundry products in a dosing unit.

Combinations of one selected from 1.1 to 1.8 (5 ml) with one selected from 2.1 to 2.12 (5 ml) and one selected from 3.1 and 3.2 (12 ml) each provided a 22 ml dose of a biological laundry detergent particularly effective for cleaning protein-based and fat-based stains.

Combinations of one selected from 1.1 to 1.8 (5 ml) with one selected from 3.1 and 3.2 (12 ml) each provided a 17 ml dose of a biological laundry detergent particularly effective for cleaning protein-based stains.

Combinations of one selected from 2.1 to 2.12, (5 ml), and one selected from 3.1 and 3.2 (12 ml) each provided a 17 ml dose of a biological laundry detergent particularly effective for cleaning fat-based stains.

A 12 ml dose of 3.1 or 3.2 provided a non-biological detergent.

The provision of the compact, concentrated stock compositions provides enhanced versatility as it makes multiple laundry products available the domestic user without requiring significant storage space. These example stock compositions provide sufficient amounts for at least 25 detergent compositions.

The relative volumes of each stock composition may be adjusted in dependence upon the level of enzyme required in the wash liquor (in accordance with the level/type of staining).

Additional reservoirs may be provided which include further detergent ingredient compositions such as bleaches, perfumes and sequestrants, for example.

A reservoir containing an enzyme formulation may also include detergent so that a third reservoir for detergent need not be necessary.

1. A detergent composition provided in a combination of reservoirs to enable a user to formulate doses of detergent compositions on demand for supplying to a washing machine drum, the combination comprising:
a first reservoir containing a stock of a first composition containing a protease component; and
a second reservoir containing a stock of a second composition containing at least one selected from a lipase component and/or a cellulase component; and
a stock of detergent wherein the product is dispensed via a computer module according to data input via a user interface which includes a facility to input data in sets, using two sets of options.

2. The detergent composition according to claim 1 wherein a stock of detergent is provided in a third reservoir.

3. The detergent composition according to claim 1 wherein the first composition contains a protease in an amount of 0.01% to 5% active enzyme protein (aep).

4. The detergent composition according to claim 1 wherein the protease enzyme has an optimum pH in a range of 6 to 10.

5. The detergent composition according to claim 1 wherein the second composition contains a lipase.

6. The detergent composition according to claim 1 wherein the second composition contains a lipase in an amount of 0.01% to 5% active enzyme protein (aep.

7. The detergent composition according to claim 1 wherein the lipase enzyme has an optimum pH in a range of 5-9.

8. The detergent composition according to claim 1 wherein the second composition contains a cellulase.

9. The detergent composition according to claim 1 wherein the second composition contains a cellulase in an amount of 0.01% to 5% active enzyme protein (aep).

10. A detergent composition according to claim 1 wherein the first composition includes a pectate lyase in an amount of 0.01% up to 5% active enzyme protein (aep).

11. The detergent composition according to claim 1 wherein the second composition includes at least one selected from (i) alpha amylase in an amount of from 0.01% to 5% active enzyme protein (aep); and/or (ii) mannanase in an amount of from 0.01% to 5% active enzyme protein (aep).

12. The detergent composition according to claim 1 in which a third reservoir includes a stock of detergent containing at least 40 wt % of a non-soap surfactant system which contains anionic and/or nonionic surfactant.

13. A system for a user to formulate bespoke laundry products on demand, the system comprising reservoirs of laundry product components and an apparatus which comprises a dosing unit for supplying a dose of laundry product to a washing machine drum and a device operable to selectively dispense portions of components from the reservoirs as a result of command by the user to provide a dose of laundry product ready for a wash process in the dosing unit, wherein the system includes a first reservoir of a composition containing a protease component, a second reservoir of a composition containing at least one selected from a lipase and/or a cellulase component and a reservoir of detergent characterised in that the product is dispense via a computer module according to data input via a user interface which includes a facility to input data in sets, using two sets of options.

14. The system according to claim 13 comprising a combination of reservoirs comprising each individually, a protease component, a lipase and/or cellulase component and detergent.

15. An apparatus for providing laundry product, the apparatus comprising a dosing unit and a dispensing device having reservoirs for containing laundry product components, wherein the device is operable to selectively dispense portions of components from the reservoirs so as to provide a dose of laundry product in the dosing unit as a result of input by a user wherein the apparatus has a first reservoir containing a stock of a composition containing a protease component and a second reservoir containing a stock of a composition containing at least one selected from a lipase and/or cellulase component.

16. The detergent composition according to claim 3 wherein the first composition contains a protase in an amount of 0.05% to 2% active enzyme protein (aep).

17. The detergent composition according to claim 4 wherein the pH is in a range of 8 to 10.

18. The detergent composition according to claim 6 wherein the second composition contains a lipase in an amount of 0.05% to 2% active enzyme protein (aep).

19. The detergent composition according to claim 7 wherein pH is in the range of 8 to 10.

20. The detergent composition according to claim 9 wherein the second composition contains cellulase in an amount of 0.05% to 2% active enzyme protein (aep).

21. The detergent composition according to claim 10 wherein the first composition includes pectate lyase in an amount of 0.05% to 2% active enzyme protein (aep).
